(19) United States
(12) Patent Application Publication
(10) Pub. No.: US 2003/0161606 A1
(43) Pub. Date: Aug. 28, 2003

(54) Display device and light guide plate

(75) Inventors: Youichiro Goto, Gifu (JP); Toru Nose, Gifu (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: SANYO ELECTRIC CO., LTD.

(21) Appl. No.: 10/373,879

(22) Filed: Feb. 27, 2003

(30) Foreign Application Priority Data
Feb. 28, 2002 (JP) 2002-054190

(51) Int. Cl. G02B 6/10

(52) U.S. Cl. 385/146; 385/901

(57) ABSTRACT

A display device includes a light guide plate. A light incident on the light guide plate from a linear light source is reflected by a wall surface forming each of grooves and irradiated onto a liquid crystal panel unit. Furthermore, a light striking the wall surface at an incident angle equal to or less than a critical angle is transmitted through the wall surface; however, a part of a transmitted light comes again into the light guide plate through another wall surface, and another part of the transmitted light travels straight outwardly without striking the wall surface.

### BACKGROUND OF THE INVENTION

1. Field of the Invention

The present invention relates to a display device and a light guide plate. More specifically, the present invention relates to a front light type display device provided with a light guide plate formed with grooves on its upper surface, and the light guide plate.

2. Description of the Prior Art

As conventional such a kind of display device, there is a liquid crystal display device 1 as shown in FIG. 6. As shown in FIG. 6, the liquid crystal display device 1 includes a linear light source 2, a light guide plate 3 placed in a state one side surface 3a thereof is along a longitudinal direction of the linear light source 2, and a reflective type liquid crystal panel 4 placed below a lower surface 3b of the light guide plate 3.

The light guide plate 3 is, on its upper surface 3c, formed with a number of linear prisms 5 in parallel with the side surface 3a. Each of prisms 5, 5, . . . has a chevron-shape in cross-section in a longitudinal direction, and each of slopes 5a, 5a, . . . opposed to the side surface 3a functions as a reflecting surface. More specifically, a light incident on the light guide plate 3 from the liner light source 2 through the side surface 3a is reflected by each of the reflecting surfaces 5a and emitted from the lower surface 3b of the light guide plate 3 as shown by a dotted arrow 6 in FIG. 6. Then, the emitted light is irradiated onto the liquid crystal panel 4, reflected upwardly by a reflecting layer 4a provided at a bottom of the liquid crystal panel unit 4, and then emitted from the upper surface 3c through the light guide plate 3.

Furthermore, as another prior art, there is a display device 1a utilizing a light guide plate 8 formed with a plurality of elongated grooves 7 having a schematically V-letter-shape in cross-section in a longitudinal direction as shown in FIG. 7 in place of the above-described chevron-shaped prisms 5, 5, . . . . In the light guide plate 8, each of the grooves 7 functions as a prism. More specifically, a light incident on the light guide plate 8 from a linear light source 2 through a side surface 8a is reflected by a slope 7a opposed to the side surface 8a of each groove 7 as shown by a dotted arrow 9 in FIG. 7, and emitted from a lower surface 8b of the light guide plate 8. Then, the emitted light is, as similar to the above-described case, irradiated onto the liquid crystal panel 4, reflected upwardly by the a reflecting layer 4a, and then emitted from an upper surface 8c through the light guide plate 8.

However, in the prior art shown in the above-described FIG. 6, since a light striking each of the reflecting surfaces 5a at an incident angle θ equal to or less than a critical angle as shown by one-dotted arrow 6a shown in FIG. 8 leaks outwardly through the reflecting surface 5a, there are problems of decreasing an emission efficiency of the light guide plate 3 (a ratio of a light amount emitted from the lower surface 3b with respect to a light amount incident from the side surface 3a) and decreasing a luminance of a screen.

On the other hand, similarly in the FIG. 7 prior art, a light leaks from each of reflecting surfaces 7a; however, a leaked light comes again into the light guide plate 8 through other surface 7b forming the groove together with the reflecting surface 7a as shown by one-dotted arrow 9a in FIG. 9 and is reused so as to be emitted to the same direction as a light shown by a dotted arrow 9. According to the FIG. 7 prior art, it is possible to more improve the luminance of the screen than the FIG. 6 prior art. However, not all the light striking the surface 7b through the reflecting surface 7a comes again into the light guide plate 8 through the surface 7b, and a part of the light is as shown by a two-dotted arrow 9b in FIG. 9 reflected (surface-reflected) by the surface 7b, further reflected by the reflecting surface 7a, and then advanced to a front direction (upper direction in FIG. 9) of the screen. When the light thus leaks in the front direction of the screen in the front light type liquid crystal display device 1a, the leaked light is overlapped with an original light (a light follows a track shown by the arrow 9 in FIG. 7) emitted to the same direction and therefore, a contrast of the screen is decreased.

### SUMMARY OF THE INVENTION

Therefore, it is a primary object of the present invention to provide a novel display device and a light guide plate.

Another object of the present invention is to provide a display device and a light guide plate capable of preventing a decrease in contrast while improving a luminance of a screen.

A display device according to the present invention is a front light type display device, and comprises: a light guide plate; and a groove formed on an upper surface of the light guide plate and having a first surface for receiving a light incident on a side surface of the light guide plate and a second surface for receiving a light transmitted through the first surface, wherein a height of the second surface is lower than a height of the first surface.

A light guide plate according to the present invention is a light guide plate having an upper surface and a light comes into one side surface thereof, and comprises: a groove formed on upper surface and having a first surface for receiving the light and a second surface for receiving a light transmitted through the first surface, wherein a height of the second surface is lower than a height of the first surface.

In the present invention, the light incident from the side surface of the light guide plate is reflected by the first surface. It is noted that although a light striking the first surface at an incident angle equal to or less than the critical angle is leaked outwardly through the first surface, the light leaked outwardly comes again into the light guide plate through the second surface, and reused so as to be emitted again in a direction originally desired to be emitted. It is noted that not all the light striking the second surface comes again into the light guide plate through the second surface, but a part of the light is reflected by the second surface. Then, due to the influence of the reflected light, there is a case that a contrast of a screen is decreased. However, since the height of the second surface is lower than the height of the first surface, the light transmitted through an upper portion of the first surface out of the light transmitted through the first surface advances straight without striking the second surface. That is, an amount of light striking the second surface is limited and therefore, an amount of light reflected by the second surface in an undesirable direction is decreased.

It is noted that the groove is extended in a linear manner, and the groove may be formed in a plural number to be spaced with each other in a direction of a width of the plate. In this case, it is desirable that the height of at least one of the first surface and the second surface forming each groove is made higher with being away from the side surface or an incident surface. This makes it possible to increase an amount of light reflected by the first surface or an amount of light comes again into the light guide plate through the second surface in a place far from the incident surface i.e., in a place where an intensity of the incident light is low and therefore, even in a place far from the incident surface, it is possible to obtain as much the luminance as in a place near the incident surface.

According to the present invention, a light leaked outwardly from the first surface comes again into the light guide pate through the second surface, and reused so as to be emitted again in a direction originally desired to be emitted. On the other hand, a part of the light transmitted through the first surface is reflected by the second surface; however, the height of the second surface is lower than that of the first surface and therefore, an amount of the light reflected by the second surface can be decreased. That is, there are advantages of capable of improving the luminance of the screen by reusing the light transmitted through the first surface and also preventing a decrease of the contrast due to the fact that the light transmitted through the first surface is reflected by the second surface.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configurative view when viewing from a lateral direction a liquid crystal display device of one embodiment of the present invention;

FIG. 2 is an illustrative view showing in a form of graph a height of each of wall surfaces depending upon distances from an incident surface of a light guide plate in a FIG. 1 embodiment;

FIG. 3 is an illustrative view showing a track or locus of a light incident on the light guide plate in FIG. 1 embodiment;

FIG. 4 is an illustrative view showing another track or locus of a light different from FIG. 3;

FIG. 5 is an illustrative view showing a manufacturing process of a metal mold for molding to manufacture the light guide plate in FIG. 1 embodiment;

FIG. 6 is a schematic configurative view when viewing from a lateral direction a conventional liquid crystal display device;

FIG. 7 is a schematic configurative view showing another prior art different from FIG. 6;

FIG. 8 is an illustrative view showing a track of a light incident on a light guide plate in the FIG. 6 prior art; and

FIG. 9 is an illustrative view showing a track of a light incident on a light guide plate in the FIG. 7 prior art.

### DETAILED DESCRIPTION OF THE PREFERRED EMBODIMENTS

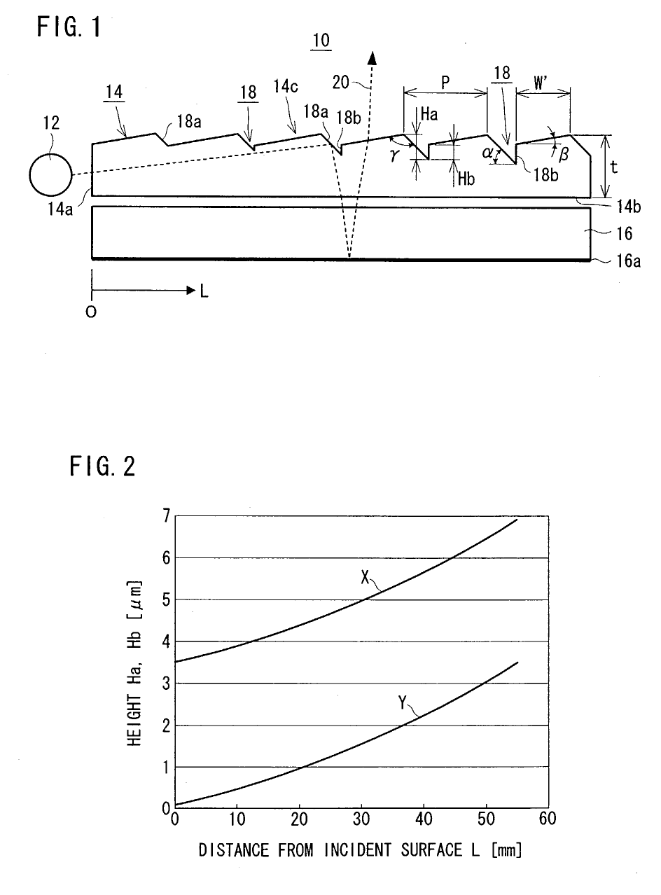

Referring to FIG. 1, a front light type liquid crystal display device 10 of the embodiment includes a linear light source 12, a light guide plate 14 placed in a state one side surface 14a is along a longitudinal direction of the linear light source 12, and a plate-shaped liquid crystal panel 16 placed below a lower surface 14b of the light guide plate 14.

Herein, the linear light source 12 is, for example, a cold-cathode tube. Then, the light guide plate 14 is made of acrylic (PMMA) resin having transparency, and formed on its upper surface 14c with a number of linear grooves 18 (described later) which extend in parallel with the side surface 14a and are formed at a constant pitch (P) in a direction of a width of the plate (lateral direction in FIG. 1). It is noted that each of the grooves 18 is shown in an enlarged manner for the sake of convenience of description, and therefore, the number of the grooves 18 shown in FIG. 1 is smaller than that of a product to which the present invention is embodied. The liquid crystal panel 16 is a reflective type having a reflecting layer 6a at its bottom and, although not shown in detail, is formed by laminating the reflecting layer 16a, a liquid crystal layer, a color filter, a glass substrate and a deflecting plate in this order on a glass substrate.

Each groove 18 has a schematically V-letter-shape in cross-section in its longitudinal direction. A wall surface 18a opposed to the side surface 14a of the light guide plate 14 out of two wall surfaces 18a and 18b forming each groove 18 forms a fixed angle α with a lower surface 14b of the light guide plate 14. Other surface 18b forms a right angle (more or less larger than the right angle due to draft of a resin molding described later) with the lower surface 14b of the light guide plate 14.

Furthermore, a height Hb of the wall surface 18b is made lower than a height Ha of the wall surface 18a for each groove 18. More specifically, by inclining to a side of the side surface 14a the upper surface 14c of the light guide plate 14 for each section sandwiched between respective grooves 18, 18, . . . (that is, by inclining the upper surface so as to make the side of the side surface 14a lower), the height Hb of the wall surface 18b becomes lower than the height Ha of the wall surface 18a for each groove 18. It is noted that a tilt angle β formed by the lower surface 14b and the upper surface 14c of the light guide plate 14 is uniform or constant for each groove 18, 18, . . . . More specifically, an angle γ formed by the upper surface 14c and the wall surface 18a of each groove 18 is uniform or constant.

In addition, by making a depth of each groove 18 deeper in a direction away from the side surface 14a, the height Ha of the wall surface 18a corresponding to the depth of each groove 18 is made gradually higher in a direction away from the side surface 14a. Following this, the height Hb of the wall surface 18b also becomes gradually higher in a direction away from the side surface 14a. FIG. 2 shows changes of the heights Ha and Hb of the respective wall surfaces 18a and 18b depending upon the distances L from the side surface 14a in a form of graph.

FIG. 2 is one example in a case the light guide plate 14 having a size in a direction vertical to the side surface 14a (lateral direction in FIG. 1) of 56.56 [mm], a size along a longitudinal direction (a front and back direction of the paper in FIG. 1) of the side surface 14a (linear light source 12) of 74.23 [mm], and a size of a thickness t of 1 [mm]. Then, a curve X shown in FIG. 2 shows a change of the heights Ha of the wall surfaces 18a depending upon the distances L, and a curve Y shows a change of the heights Hb of the wall surfaces 18b depending upon the distances L. As can be understood from these curves X and Y, the higher the height Ha of the wall surface 18a is in a range of 3.5 [μm]-6.9 [μm] in an exponential function manner, the larger the distance L from the side surface 14a is. On the other hand, the height Hb of the side surface 18b is 3.4 [μm] or so lower than the height Ha of the wall surface 18a in each distance L, that is, it changes in a range of 0.1 [μm] to -3.5 [μm] in an exponential function manner depending upon the distances L. It is noted that each pitch P between the grooves 18, 18, . . . is one hundred and several dozen [μm] to several hundred [μm] or so.

According to the liquid crystal display device 1 thus structured, each groove 18 acts as a prism. A light incident on the light guide plate 14 from the linear light source 12 through the side surface 14a is directly struck and reflected by each of wall surfaces 18a, 18a, . . . opposed to the side surface 14a as shown by a dotted arrow 20 in FIG. 1 and emitted from the lower surface 14b of the light guide plate 14. Then, the emitted light is irradiated onto the liquid crystal display panel 16, reflected by the reflecting layer 16a upwardly through the above-described liquid crystal layer, and then transmitted again through the liquid crystal layer. The light having been transmitted through the liquid crystal layer is emitted from the upper surface 14c through the light guide plate 14.

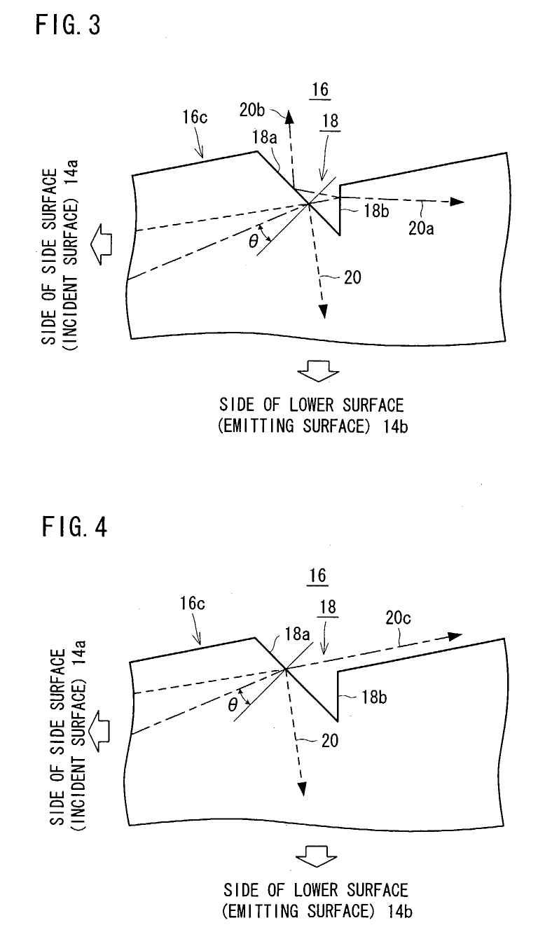

It is noted that a light striking each wall surface 18a at an incident angle θ equal to or less than the critical angle leaks outwardly through the wall surface 18a. A light leaked from the lower portion (generally, a portion having a height as tall as the height Hb of the other side surface 18b) of the wall surface 18a out of a leaked light comes again into the light guide plate 16 as shown by one dotted arrow 20a in FIG. 3 through the wall surface 18b. The light incident again on the light guide plate 16 is reused in order to be emitted again to the same direction as a light shown by a dotted arrow 20 (in order to be reflected by a wall surface 18a of another groove 18). Thus, by receiving the light having been leaked outside the light guide plate 16 and reusing it within the light guide plate 16 again, it is possible to improve the luminance of the screen.

It is noted that not all the light striking the wall surface 18b comes again into the light guide plate 16 through the wall surface 18b, and a part of the light as shown by a two dotted arrow 20b in FIG. 3 is reflected by the side surface 18b, also reflected by the wall surface 18a and advanced toward a front direction (upper direction in FIG. 3) of the screen. Then, the light advances straight toward a direction approximately along the upper surface 16c of the light guide plate 16. Thus, the light leaked to the front direction of the screen is overlapped with an original light (light following a track shown by an arrow 20 in FIG. 3) emitted to the same direction and therefore, a contrast of the screen is decreased.

However, since the height Hb of the wall surface 18b is made lower than the height Ha of the wall surface 18a, a light which transmits an upper portion of the wall surface 18a (generally, a portion taller than the height Hb of the wall surface 18b) out of the transmitted light through the wall surface 18a travels straight outwardly along the upper surface 14a of the light guide plate 14 without striking another wall surface 18b as shown by one dotted arrow 20c in FIG. 4. That is, an amount of light striking the wall surface 18b is limited and therefore, it is possible to decrease an amount of light reflected by the wall surface 18b toward an undesirable direction and hence to prevent the decrease of the contrast of the screen due to the undesirably reflected light.

Furthermore, each of the heights Ha and Hb of each of the wall surfaces 18a and 18b generally becomes higher with being away from the side surface 14a and therefore, even in a place far from the side surface 14a, it is possible to obtain as much the luminance as in a place near the side surface 14a. As described this in detail, the light illuminated from the linear light source 12 is attenuated as a propagation distance becomes long. Accordingly, the further the wall surface 18a out of the wall surfaces 18a is located from the incident surface being the side surface 14a, the lower the light intensity from the linear light source 12 is. Similarly, the further the wall surface 18b out of the wall surfaces 18b is located from the side surface 14a, the lower the light intensity leaked outwardly through the wall surface 18a, i.e., the light intensity received by the wall surface 18b is. Herein, as shown in this embodiment, if the further the wall surface 18a and the wall surface 18b out of wall surfaces 18a and 18b are located from the side surface 14a, the larger the heights Ha and Hb of the respective wall surfaces, i.e., light reflection areas and light capture areas are, it is possible to compensate decrease of the light intensity depending upon the distances L from the side surface 14a. Thus, even in a place far from the side surface 14a as the incident surface, it is possible to obtain as much the luminance as in a place near the side surface 14a, and it becomes possible to obtain a uniform luminance distribution over the screen.

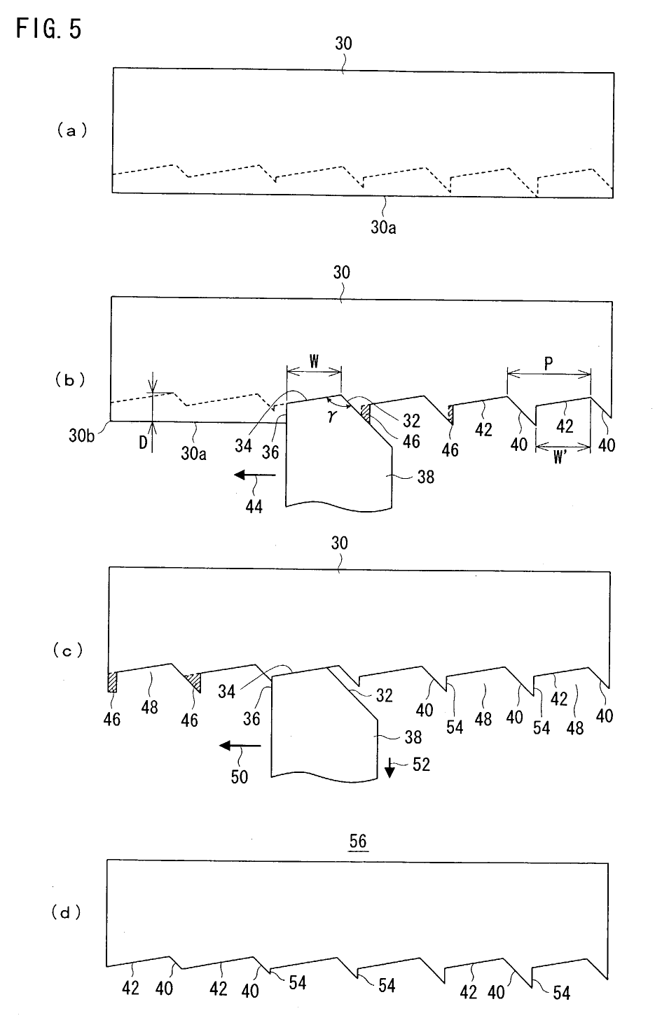

Meanwhile, the light guide plate 14 according to the embodiment can be formed by resin molding (e.g., injection molding), and a metal mold utilized for the resin molding can be manufactured by a process shown in FIG. 5. More specifically, as shown in FIG. 5(a), a rectangle metal body 30 is prepared as a material for the metal mold.

As shown in FIG. 5(b), one surface 30a of the metal body 30 is cut by a bite 38 having a first cutting edge 32, a second cutting edge 34 and a third cutting edge 36 in a direction parallel to one periphery edge 30b of the one surface 30a (a front and back direction of the paper in FIG. 5). At this time, cutting by the first cutting edge 32 forms a portion 40 corresponding to the wall surface 18a of the light guide plate 14, and cutting by the second cutting edge 34 forms a portion 42 corresponding to the upper surface 14c of the light guide plate 14. Then, as shown by an arrow 44, the same cutting work is repeated in a manner that a position of the bite 38 is moved by a distance the same as the above-described pitch P in a direction perpendicular to the one periphery edge 30b.

It is noted that a depth D of the cutting is fixed. Then, the depth D is equal to the depth of the deepest groove 18 or the height Ha of the tallest wall surface 18a. Furthermore, a width W of the second cutting edge 34 of the bite 38 is equal to the width W of the narrowest section (section at the right end in FIG. 1) out of sections sandwiched between the respective grooves 18, 18, . . . on the upper surface 14c of the light guide plate 14. Furthermore, the first cutting edge 32 and the second cutting edge 34 form an angel the same as the angle γ formed by the upper surface 14c of the light guide plate 14 and the wall surface 18a.

Simply repeating the cutting works at a constant interval P results in a so-called unfinished portion to be cut indicated by oblique hatching 46 as shown in FIG. 5(b). Thereupon, after completion of a set of the cutting works (or the required number of times) at fixed intervals P, another set of cutting works are performed so as to remove the unfinished portion 46.

That is, as shown in FIG. 5(c), a position of the bite 38 is moved by a predetermined amount every concave portion 48 cut by first cutting works and lowered in a direction indicated by an arrow 52 corresponding to the amount of the movement. Then, by performing cutting in this state, a portion 42 corresponding to a remaining upper surface (unfinished by the first cutting work) 14c and a portion 54 corresponding to the wall surface 18b are formed. After completion of cutting all the rest of the unfinished portion 46, the metal mold 56 is manufactured.

As can be understood from the above description, according to the liquid crystal display device 10 of this embodiment, a light incident on the light guide plate 14 through the side surface 14a from the linear light source 12 is reflected by the wall surface 18a being a reflecting surface and irradiated onto the liquid crystal panel 16. Furthermore, although the light striking the wall surface 18a at the incident angle θ equal to or less than the critical angle is transmitted and leaked through the wall surface 18a, a part of the leaked light comes again into the light guide plate 16 through the other wall surface 18b and reused in order to improve the luminance. On the other hand, a part of the light striking the wall surface 18b is reflected to an undesirable direction by the wall surface 18b; however, the height Hb of the wall surface 18b is lower than the height Ha of the wall surface 18a and therefore, an amount of the reflected light by the wall surface 18b is decreased. Consequently, it is possible to prevent the decrease of the contrast due to the reflected light.

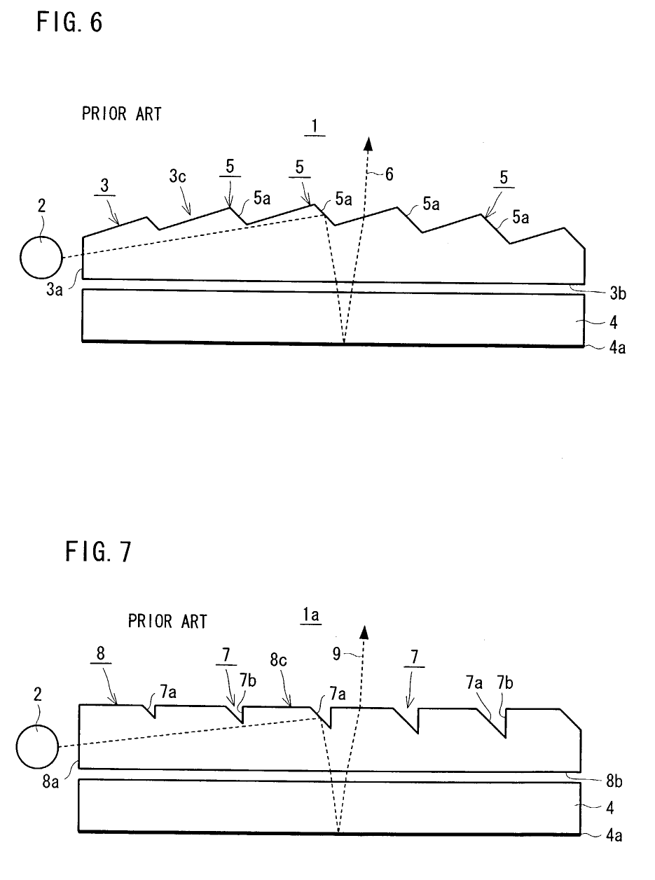

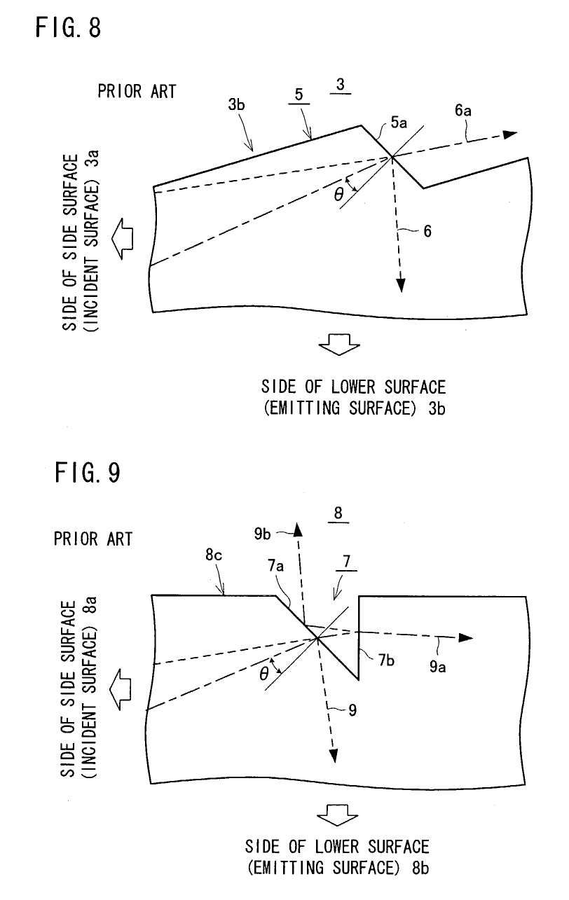

Advantages of the embodiment are summarized in a table 1 in comparison with the FIG. 6 and FIG. 7 prior arts.

TABLE 1

| | | | low-profile |
|---|---|---|---|
| | luminance | contrast | (thickness of plate) |
| FIG. 6 prior art | X | ◯ | X |
| (chevron-shaped | | | |
| prism) | | | |
| FIG. 7 prior art | ◯ | X | ◯ |
| (groove-shaped prism) | | | |
| embodiment | ◯ | ◯ | ◯ |

As can be understood from the table 1, according to the FIG. 6 prior art, a high contrast can be obtained while a sufficient luminance cannot be obtained. On the other hand, according to the FIG. 7 prior art, a high luminance can be obtained while a contrast is low. On the contrary thereto, according to the embodiment, a high luminance and a high contrast can be obtained. That is, it is possible to realize the liquid crystal display device 10 offering an excellent compromise between the FIG. 6 and FIG. 7 prior arts.

In addition, as described above, by gradually making the heights Ha and Hb of the respective wall surfaces 18a and 18b higher with being away from the side surface 14a in this embodiment, it is possible to obtain a uniform luminance distribution over the whole screen. Similarly, in the FIG. 6 prior art also, making the height of each prism 5 (slope 5a) higher with being away from the side surface 3a, it is possible to obtain a uniform luminance distribution over the whole screen (FIG. 6 takes such structure). However, when applying such the structure to the FIG. 6 prior art, the upper surface 3c of the light guide plate 3 necessarily swells out as exaggeratedly shown in FIG. 6, and this increases the thickness (thickness of plate) of the light guide plate 3 itself and also increases the total thickness of the liquid crystal display device 1. On the contrary thereto, in this embodiment, owing to forming a prism by a groove 18, even if the heights Ha and Hb, that is, the depth of each of wall surfaces 18a and 18b is made higher, the thickness t of the light guide plate 14 itself is never increased. That is, as shown in the column at the right end in the table 1, this embodiment is very effective for making the liquid crystal display device 10 low-profile. This holds true for the FIG. 7 prior art in which a prism is formed by a groove 7.

It is noted that although the wall surface 18b as a re-incidence surface is formed at an approximately right angle to the lower surface 14c of the light guide plate 14 in the embodiment, it is not limited thereto. That is, the wall surface 18b may be formed in a slanting direction to the lower surface 14c of the light guide plate 14.

Furthermore, the numerals of the heights Ha and Hb of the respective side surfaces 18a and 18b as shown in a FIG. 2 graph are just an example, and it is not limited thereto.

Then, although the light guide plate 14 is formed by the resin molding in the embodiment, another forming method is available.

In addition, although the light guide plate 14 is made of acrylic resin, another resin having transparency such as polycarbonate (PC) and etc. may be available. Although a cold-cathode tube is utilized as the linear light source 12, it is not limited thereto, and another fluorescent lamp such as a hot-cathode tube and etc., light emitting diodes arranged in a linear manner, or an incandescent lamp or an organic light-emitting member arranged in a linear manner may be used.

Then, although each of the grooves 18, 18, . . . is provided in parallel with the side surface 14a being an incident surface, each of the grooves 18, 18, . . . may be provided in a manner of extending in a slanting direction with respect to the side surface 14a, i.e. with respect to a liquid crystal pattern arrangement direction not shown within the liquid crystal panel 16. Slanting a longitudinal direction of each of the grooves 18, 18, . . . with respect to the liquid crystal pattern arrangement direction prevents occurrence of moiré fringes due to interference between them.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A front light type display device, comprising:
a light guide plate; and
a groove formed on an upper surface of said light guide plate and having a first surface for receiving a light incident on a side surface of said light guide plate and a second surface for receiving a light transmitted through said first surface, wherein a height of said second surface is lower than a height of said first surface.

2. A display device according to claim 1, wherein said groove is extended in a linear manner, and formed in a plural number to be spaced to each other in a direction of a width of the plate, and
at least one of the heights of said first surface and said second surface forming each groove makes higher with being away from said side surface.

3. A light guide plate having an upper surface and a light comes into one side surface thereof, comprising:
a groove formed on an upper surface and having a first surface for receiving the light and a second surface for receiving a light transmitted through said first surface, wherein a height of said second surface is lower than a height of said first surface.
